(19) United States
(12) Patent Application Publication
(10) Pub. No.: US 2007/0058564 A1
(43) Pub. Date: Mar. 15, 2007

(54) Method and device for managing data flow in a synchronous network

(75) Inventors: Ashok K. Agrawala, Ashton, MD (US); Michael B. Trinh, Rockville, MD (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: University of Maryland, College Park, MD (US)

(21) Appl. No.: 11/491,420

(22) Filed: Jul. 21, 2006

Related U.S. Application Data
(60) Provisional application No. 60/702,425, filed on Jul. 26, 2005.

(51) Int. Cl. H04L 12/26; H04J 1/16

(52) U.S. Cl. 370/252

(57) ABSTRACT

A Cyclone Network Synchronization algorithm is presented that does not depend on highly stable and expensive clocks or hardware, yet it can synchronize nodes in a network with a very high degree of accuracy. It is very light-weight since no clock synchronization is performed, and subsequently does not incur any overhead in message passing. Instead, synchronization is done solely by listening to the regular network traffic. Finally, the amount of padding or time overhead incurred by the CNS algorithm is extremely small, even when used with system clocks that have high drift rates (e.g. 1000 PPM or more).

### PRIORITY

This application claims priority from a U.S. Provisional Application filed on Jul. 26, 2005 and assigned U.S. Provisional Application Ser. No. 60/702,425; the entire contents of which are incorporated herein by reference.

### BACKGROUND

1. Technical Field

The disclosure relates to synchronous networks. In particular, the disclosure relates to a method and device, including a synchronization algorithm, for managing data flow in a high-speed, synchronous network, such as a Cyclone network. The synchronization algorithm does not require the clocks at the various nodes to be synchronized with respect to each other or with a global clock.

2. Description of the Prior Art

The constant need to quickly send a larger amount of data from one place to another has transformed high-speed networks into an essential part of the various existing wide area networks such as the Internet. In a high-speed synchronous network, the nodes coordinate the exchange of information on the basis of time. The sender is expected to be sending at a particular time instance, and assuming network latency is factored in, the receiver is expected to be receiving at some known time instance later. As a result, it is important that the nodes in the system be able to calculate or predict the time at which data is to be sent and received. The more accurate or precise the time calculation, the smaller the interval with which the receiver has to watch for the incoming data. This can lead to a higher link utilization rate, as well as a lower end-to-end delay.

One way to obtain this “synchronized” behavior is to use highly “accurate” clocks, or clocks that have very small amount of drift relative to each other (e.g. cesium clocks) in the system, and perform explicit clock synchronization among the nodes to account for these small drift amounts. The disadvantage of this approach is that the cost of the hardware can be significant, as cesium-class clocks can cost in the ten of thousand of dollars. Furthermore, since clock synchronization and distribution are still required in most cases, these can add additional overhead to the system in terms of the bandwidth needed for sending synchronization messages or resources needed to distribute the clock signals.

The Cyclone Technology is a network architecture developed at the University of Maryland at College Park, College Park, Md., and described in technical papers and in U.S. Pat. No. 6,320,865 issued to Agrawala et al. on Nov. 20, 2001; the entire contents of which are incorporated herein by reference. Unlike traditional network architectures that schedule network resources whenever they are needed at run-time (“on-demand” basis), Cyclone takes a different approach. In Cyclone, time is explicitly considered as a resource, similar to the buffers at a node or the bandwidth of a link. Furthermore, Cyclone attempts to schedule every resource in the network a priori, or before the time of actual usage.

In Cyclone, when a node needs to send buffer B at time T, both the location of B and the value of T are known or scheduled beforehand. Thus, in a Cyclone network, every node knows the exact time it is to receive data from its incoming links, and knows the exact time it is to send or forward these data to its outgoing links. The arrival or departure time of a piece of data determines the routing information. There is no routing information stored in a Cyclone “packet” (which is referred to as a “chunk”). This is unlike the case in a traditional network, where “packets” contain information such as where they originate from and where they are destined for in their header (e.g. “source and destination IP addresses”).

Cyclone performs end-to-end resource reservation at connection setup time. All the resources required by this particular connection across the entire Cyclone network are scheduled in advance, assuming that these resources (namely the buffers at each Cyclone node to store the chunks) are available. If they are not available, because the demand of the connection exceeds the available resources, the connection will be rejected by the Cyclone network. Subsequently, acceptance of a connection by the network implies that its resource requirements, both in terms of link bandwidth and buffers at the intermediate nodes, will be guaranteed when data actually flows across this connection.

The basic unit of network data in a Cyclone network is a constant size unit called a “chunk”. A fixed number of chunks are sent in a “cycle”. A cycle consists of a “transmission period”, in which the chunks are transferred back to back, followed by an “adjustment period”, which may be empty and is used for synchronization. Both the chunk size, in terms of the number of bytes, as well as the length of the cycle, in terms of number of seconds, are determined at network design time.

A Cyclone node repeatedly sends data one cycle after another. The timing information that specifies when chunks are scheduled to arrive and depart is stored in a structured called a “calendar” on each node. In other words, the calendars are used to reserve the resources at that node. At run time, a Cyclone node simply scans through its calendar at the appropriate time to determine on which outgoing link to forward a chunk arriving on an incoming link. As mentioned above, this avoids the need to perform a header lookup to determine routing information.

Cyclone offers several advantages over the traditional network architectures. Since resources are reserved and scheduled before they are needed, QoS applications can be supported more effectively, as there will be no network resource contention at run time, which eliminates congestion or buffer overflow at a Cyclone node, which in turn results in no loss, duplication, or out-of-order data. In addition, the network end-to-end delay is bounded, and the jitter is minimized. Finally, because there is a no need to encode routing information within a packet or chunk, header overhead are smaller, potentially leading to a higher link utilization rate.

From the description above, it is evident that accurate timing is an important, if not the most important, aspect of the Cyclone network, especially since routing information is encoded implicitly in the arrival and departure time of a chunk. If the Cyclone nodes are not synchronized sufficiently, and the arrival time of a chunk is miscalculated, there will simply be no way to determine this error after the fact. If chunk N arrived at the wrong time, say at the time when N+1 is supposed to be arriving, then chunk N will simply be routed to where chunk N+1 would have been sent. To make matter worse, this timing error will cascade indefinitely from this point onward (e.g. chunk N+1 will be sent to where chunk N+2 would have been sent, etc.). The Cyclone network is therefore designed specifically to eliminate this type of timing failure.

Accurate timing is also important when it comes to the scheduling of resources, or buffers, at a Cyclone node. The more precise the timing, e.g., if we know a chunk is scheduled to arrive between 4:59 and 5:01 instead of between 4:30 and 5:30, the more flexibility we have in making reservations in the calendar, e.g., we can schedule this chunk to be sent out anytime after 5:01 instead of having to wait until after 5:30. Better schedules can translate to potentially more connections being accepted at setup time and smaller end-to-end delays in the network.

### SUMMARY

It is an aspect of the present disclosure to provide a method and device, including a synchronization algorithm, for enabling each node in a synchronous network to coordinate with all the other nodes in the network the time at which chunks are scheduled to be sent and received within a cycle to maintain an end-to-end coordinated schedule for synchronous operation. This is achieved in accordance with the present disclosure without requiring the individual clock at each node to be synchronized with the individual clocks of the other nodes or with a global clock.

The present disclosure provides a method, device and synchronization algorithm for enabling each node in a synchronous network to coordinate with all the other nodes in the network the time at which chunks are scheduled to be sent and received within a cycle to maintain an end-to-end coordinated schedule for synchronous operation.

In particular, the present disclosure provides a Cyclone Network Synchronization (CNS) algorithm for use in synchronous networks, such as a Cyclone network as described in U.S. Pat. No. 6,320,865, which improves the performance of synchronous network architectures. The methodology of the CNS algorithm does not require or depend on the individual clock at the nodes to be highly accurate, nor do they need to be synchronized with one another or with a global clock. Furthermore, no explicit synchronization data is sent. Instead, network synchronization is performed based only on the regular traffic in the network. The CNS algorithm thus can be implemented using low-cost hardware (no need to have system clocks), while offering high bandwidth utilization due to its low overhead. Finally, synchronization accuracy can be achieved at the granularity of the clock tick level. Even though the CNS algorithm has been developed specifically for use in the Cyclone network, it can be adapted for use in any high-speed network that transfers data in a synchronous manner (e.g., Sonet, DTM).

By using the CNS algorithm, each Cyclone node can coordinate with all the other nodes in the network the time at which chunks are scheduled to be sent and received within a cycle. As used herein chunks may be defined as a predetermined or predefined number of bits. Since the chunks in a given cycle are transmitted back to back, and since a Cyclone node will determine when to transmit on its outgoing links (“outgoing cycle”), each node only needs to determine the time when the first chunk of a cycle will arrive on each of its incoming link (“incoming cycle”). The arrival/departure time of the first chunk in a cycle is also referred to as the “start time” of the incoming/outgoing cycle.

The CNS algorithm allows each Cyclone node to (1) determine the start times of all the incoming cycles, and based on these info, (2) determine an appropriate start times of all the outgoing cycles. This is done by modifying the “adjustment” period at each node accordingly, such that the resulting cycle length (“transmission” plus “adjustment”) is exactly the same across the entire Cyclone network, as measured by a common external time source (such as a wall clock).

The CNS algorithm works despite the fact that the clocks on the individual Cyclone nodes are not synchronized in any way, are not required to be highly accurate (e.g., cesium clocks), and can potentially drift at different rates (although it is preferably required that these drift rates be bounded).

The present disclosure further provides a device and a data network operating according to the principles of the CNS algorithm as described above. In particular, the device coordinates among a plurality of nodes on a network the arrival and departure time of chunks. The device includes an incoming buffer for storing chunks received from the plurality of nodes; an outgoing buffer for storing chunks to be transmitted to the plurality of nodes; and a controller for determining an arrival time of a chunk corresponding to an incoming cycle, and for determining a departure time for the chunk corresponding to an outgoing cycle based on the determined arrival time. The controller determines the departure time by adding an adjustment time to a time required to transmit the chunk during the outgoing cycle, where a cycle duration length time computed as the adjustment time plus the time required to transmit the chunk during the outgoing cycle is the same across the entire network for enabling synchronous operation among the plurality of nodes. It is noted that the time for transmitting a chunk does not have to be determined explicitly. After determining the start time of a cycle and the sequence in which chunks have to be transmitted, the transmitting time gets fixed implicitly.

The device further includes a switch for switching each of the chunks from a portion of the incoming buffer to a portion of the outgoing buffer at a switching time determined by the controller. The switching time can be prior to the determined departure time or substantially equal to the departure time.

The data network according to the present disclosure includes a plurality of hosts including a sending host for sending data in chunks and a receiving host for receiving the data, and a plurality of intermediate nodes interconnecting the plurality of hosts. Each of the plurality of intermediate nodes includes incoming buffer means for storing the chunks when the chunks are received in said each of the plurality of intermediate nodes; outgoing buffer means for storing the chunks to be sent from said each of the plurality of intermediate nodes; and controller means for determining an arrival time of a chunk at said each of the plurality of intermediate nodes, and for determining a departure time for the chunk from said each of the plurality of intermediate nodes. The controller means determines the departure time by adding an adjustment time to a time required to transmit the chunk during an outgoing cycle, where a cycle duration length time computed as the adjustment time plus the time required to transmit the chunk during the outgoing cycle is the same across the entire data network.

Each of the plurality of intermediate nodes further comprises switch means for switching each of the chunks from a portion of the incoming buffer means to a portion of the outgoing buffer means at a switching time determined by the controller means.

### BRIEF DESCRIPTION OF THE FIGURES

FIG. 1 shows a Cyclone network in accordance with the present disclosure;

FIG. 2 shows a Cyclonode used in the network of FIG. 1;

FIG. 3 shows a temporal regulator used in the network of FIG. 1;

FIG. 4 shows buffering due to different clock drift rates;

FIG. 5 shows a two-windows checking scheme to minimize buffering;

FIG. 6 shows a 20-node chain network topology;

FIG. 7 shows a 20-node bidirectional cycle topology; and

FIG. 8 shows a 20-node star network topology.

### DETAILED DESCRIPTION

The following detailed description makes the following three assumptions about the Cyclone network:

Cyclone nodes are connected by unidirectional links, with a fixed and known latency value that may have small bounded jitters.

A Cyclone node has the ability to detect and “timestamp” the start time of an incoming cycle by using a hardware clock.

A Cyclone node has a finite amount of buffer for each incoming link to store the start time of the incoming cycles.

I. Cyclone Network Topology

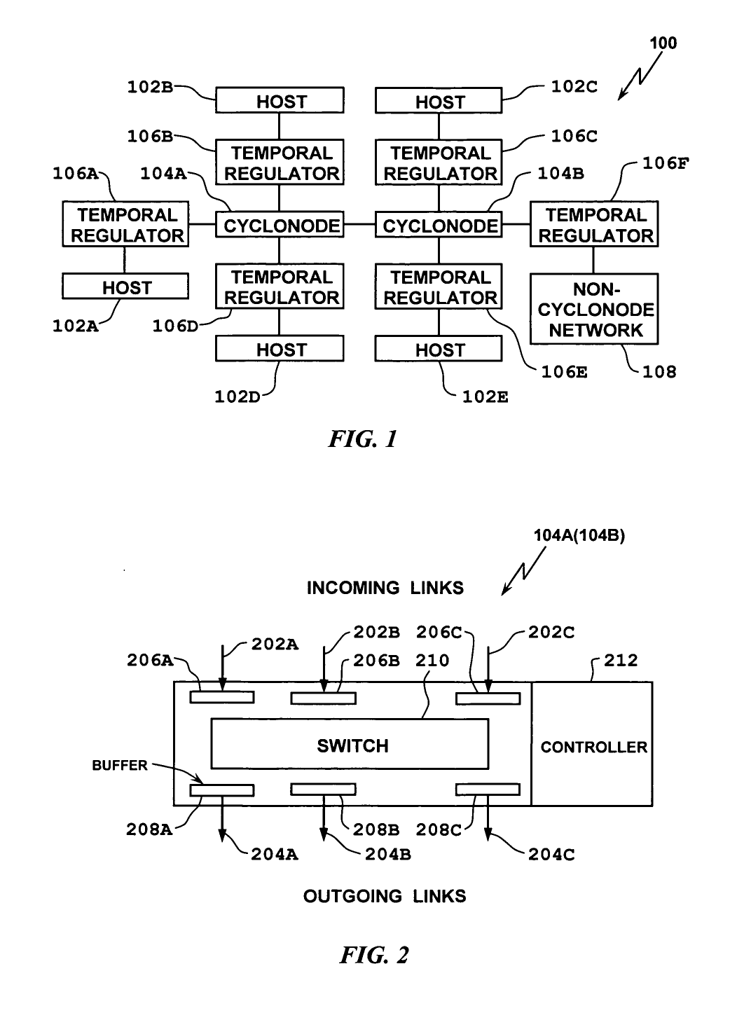

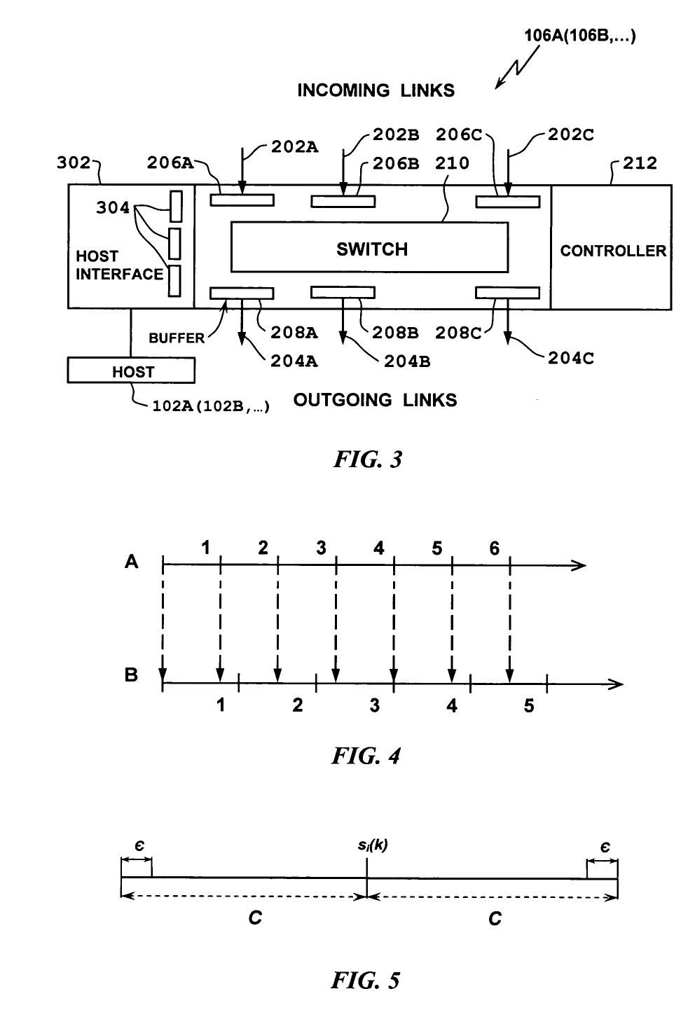

FIG. 1 shows a network constructed according to Cyclone technology. In network 100, data are transferred among hosts 102A, 102B, 102C, 102D, 102E by way of nodes 104A, 104B, called Cyclonodes. The structure and operation of each Cyclonode will be described in detail below with reference to FIG. 2. Each host interfaces with its Cyclonode by way of temporal regulator 106A, 106B, 106C, 106D, or 106E. The structure and operation of each temporal regulator will be described in detail below with reference to FIG. 3. Network 100 can also communicate with non-Cyclone network 108 by way of temporal regulator 106F. Thus, non-Cyclone network 108 appears on the Cyclone network 100 as another host. For example, network 100 can be connected to the Internet in this manner.

In the exemplary embodiment, Cyclonodes 104A and 104B have the same internal structure, shown in FIG. 2. Cyclonode 104A (104B) is connected to a plurality of incoming links 202A, 202B, 202C and a plurality of outgoing links 204A, 204B, 204C. The incoming and outgoing links are unidirectional links that operate by DMA (direct memory access) to allow data transfer among the Cyclonodes or between a Cyclonode and a temporal regulator. Each of the incoming links is connected to a corresponding one of incoming buffers 206A, 206B, 206C, while each of the outgoing links is connected to a corresponding one of outgoing buffers 208A, 208B, 208C. Each Cyclonode is implemented on a workstation.

Of course, the number of links and buffers shown is purely illustrative; any number can be used as needed for any particular network configuration. Moreover, while the exemplary embodiment is implemented with point-to-point links, other kinds of links can be used.

A link is a point-to-point data path which connects a Cyclonode to another Cyclonode or to a temporal regulator. A link operates continuously moving chunks from the send side to the receive side, or, more specifically, from a send side logical buffer (SLB) (such as outgoing buffer 208A of a Cyclonode) to a receive side logical buffer (RLB) (such as incoming buffer 206A of another Cyclonode). A logical buffer is a collection of buffers, each capable of holding one chunk, and organized in a sequence. Each buffer has a time tag, such as time tag i. In other words, a logical buffer is a buffer-based representation of time with respect to the link.

For the buffers of the SLB, the time tag indicates the time at which the transmission of the chunk in the buffer begins. For the RLB, the time tag indicates the time when the reception of the chunk in this buffer begins. Note that for any buffer in the SLB, for a link there is a buffer in the RLB. The time tags for the two corresponding buffers differ by the link delay.

As all chunks are of the same size, knowledge of the link speed allows a determination for each buffer of the time when the send or receive operation will end. This time is generally the time tag for the next buffer.

As a link is considered to operate continuously, in principle a logical buffer contains an infinite number of buffers. In practice, a finite number of buffers is used for a physical implementation of a logical buffer by reusing the buffers. The number of physical buffers required to implement a logical buffer depends on the operating characteristics of the Cyclone network and the cycle time chosen for the cyclic operations.

In Cyclone, the transfer of information on a link is controlled from the send side. Therefore, the timing information about the operation of a link is tied to the clock of the sender Cyclonode. However, as the RLB is a part of the receiving Cyclonode, the sender clock information becomes visible to that Cyclonode and can be used for clock drift adjustments.

The Cyclonode provides the functions of a store and forward switch. To move chunks to another location in the network, switch 210 shown in FIG. 2 transfers the chunks from the logical buffer of the incoming link 202A, 202B, . . . , to a logical buffer of a desired time tag of an outgoing link 204A, 204B, . . . . The data moving operation, therefore, preferably relies on the addresses of the two buffers with their defined time tags and therefore is preferably carried out after the time on the tag of the in buffer and before the time on the tag of the out buffer. This is carried out in a temporally determinate manner by maintaining a calendar for the switch operations in controller 212. Because the incoming links bring in chunks at specified times and the outgoing links send out chunks at specified times, no header lookup is required. More than one switch 210 can be provided.

Controller 212 is responsible for generating and updating the calendars for the switch(es) and the links, and managing the operations and functions of the Cyclonode. Controller 212 is responsible for connection establishment and connection teardown functions. When a communication task request comes to a Cyclonode, the controller looks up a routing table to determine the outgoing link for the connection to be used for this request. Then, based on the temporal profile information, it modifies the calendar for the switch. The calendar and the specifics of its modification will be described in detail below.

In the exemplary embodiment, there is only one switch at a Cyclonode which carries out all data movement functions. The switch can operate, e.g., by mapping an address in memory corresponding to a certain incoming logical buffer to a certain outgoing logical buffer. If there are multiple switches, a separate calendar for each is required and used for the operation of that switch.

Even though the links operate continuously, a calendar is required for them to indicate when each link is sending information chunks and where the source of the information is. The Cyclonode maintains and uses a calendar for the switch. During normal operation, the only actions carried out by the Cyclonode are by its switch, which, according to its calendar, moves chunks from the RLB of a link to SLB of another link. Controller sets up a connection when it modifies the calendar for the switch to accommodate the new connection.

FIG. 3 shows a temporal regulator (TR) 106A (106B). The structure and functionality of temporal regulator 106A (106B, . . . ) are based on those of Cyclonode 104A (104B). In addition, the temporal regulator includes host interface 302 for connection to host 102A (102B, . . . ). The host interface maintains logical buffers 304 for sending and receiving information. The switch moves information between link logical buffers 206A, . . . , 208A, . . . , and host logical buffers 304. The host interface is responsible for moving the information between the host logical buffers and the host. As logical buffers have times attached to each buffer, when information is put in the logical buffers, the information acquires a specific temporal profile that serves in the place of a packed header. The temporal regulator, like the Cyclonode, is implemented on a workstation.

An important function of the host interface is to carry out temporal matching between the temporal characteristics of the arriving or departing chunks and the information as generated or consumed by the host. Logical buffers 304 are used for this purpose.

From the network's point of view, the TR has the capability of generating traffic with a defined temporal profile on one side and of accepting traffic with a defined temporal profile on the other side. In this regard, the TR provides the capability of temporal matching. Thus, a temporal regulator can be used to provide temporal matching in order to interface Cyclone networks with hosts and with other networks.

When a TR is used to interface a Cyclone network with another network, as shown in FIG. 1, the temporal variability of the other network is absorbed through the use of buffers by the TR, so that for the Cyclone network, the communication goes on in the usual temporally defined manner.

The operation of the Cyclone network is described in U.S. Pat. No. 6,320,865 and is also described herein within the context and implementation of the Cyclone Network Synchronization (CNS) algorithm.

II. Cyclone Network Synchronization Algorithm

In this section (Section II), a detailed description of the basic Cyclone Network Synchronization (CNS) algorithm is given. An analysis on the converged cycle length as well as the convergence behavior of the algorithm is then provided. Finally, two enhancements to the basic algorithm are discussed that facilitate the implementation of CNS algorithm on actual Cyclonode hardware in a Cyclone network, such as the Cyclone network shown in FIG. 1 and described in Section I above.

II.a. Network Model

An assumption is made that network nodes, such as Cyclonodes 104 shown in FIG. 1, are connected with point-to-point unidirectional links. Operations on any particular node are controlled by the clock local to that node. The clock drift rate is not known to the node. All links send or receive continuously, and that a node can record the arrival time of any bit, as reported by its local clock. The CNS algorithm actually only depends on the ability of each node to record the arrival time of the first bit in each incoming cycle.

It is assumed that the graph that represents the Cyclone network topology is connected, i.e. that there is a path from any node to any other node. Network topology naturally introduces the concept of neighbors. Node j is a neighbor of node i, and write j→i, if there is a link from node j to node i. The neighborhood of node i is defined as the set
Uᵢ≡{j:j→i}U{i}.

It is noted that i itself is included in the set of its neighbors. The latency of the link j→i is denoted by lⱼᵢ. Finally, if there is both a j→i as well as a i→j links, lᵢⱼ may not necessarily be the same as lⱼᵢ.

II.b. Clock Model

The analysis requires consideration of clock readings in several contexts: local clock times, global clock time, and relations between clock times at neighboring nodes. Let sⁱⱼ(k) denote the start time of cycle k on node j, as interpreted by the clock on node i. In general, the clock notation follows the following conventions.

The superscript indicates which clock is recording the given interval or event of interest.

The subscript indicates the node on which the event occurred.

The “argument” provides the cycle number. The network begins operations with cycle 0, although it is not required that all nodes start operating at absolute time 0.

An absence of a superscript indicates an absolute (also called global) time reading.

Every cycle consists of a data transmission period (or simply transmission period) followed by an adjustment period. If all clocks were perfect (i.e. they do not drift at all), the lengths of the transmission period and adjustment periods would be T and Y, thus the corresponding cycle length would be C=T+Y. In addition, the kth observation period is defined to be the interval consisting of adjustment period k−1 followed by transmission period k.

Since every node can record the arrival time of any bit on its input or incoming links (202 in FIGS. 2 and 3), information about the length of a cycle at any neighbor can be collected by observing consecutive start times of the data transmissions received from that neighbor, modulo delays due to link latencies and discretization errors due to finite clock granularity.

The clock model initially assumes a constant drift rate. Specifically, it is assumed that an interval of length Δtⁱ as measured by clock i is related to the absolute time Δt according to the relation
Δtⁱ=rᵢΔt, (1)
where the clock drift rate rᵢ is fixed for each i. It is assumed that link latencies are fixed as well. Although in practice, there can be perturbation in the latencies, these are so small that over the length of a single cycle the effect is negligible. Any long term effect caused by the perturbation will be corrected by the CNS algorithm. Similarly, clock drift rates will have a second order effect. Again, this variation is small and slow enough so that the CNS algorithm corrects for it. Assuming static latencies and clock drift rates allows for providing a static analysis of the behavior of the CNS algorithm.
II.b.1. Clock Drift Rate Ratio

In the absence of a global clock, it is impossible for nodes to determine individual clock drift rates. They can, however, determine clock drift rate ratios. Specifically, an interval of absolute length Δt is measure as Δtⁱ=rᵢΔt on node i and as Δt^{j}=rⱼΔt on node j. Thus
Δtⁱrᵢ=Δt^{j}rⱼ,
or equivalently

$$Δ {t}^{j} = ( \frac{{r}_{i}}{{r}_{i}} ) Δ {t}^{i} \qquad ( 2 )$$

II.c. Algorithm

The working principle of the CNS algorithm according to the present disclosure is straightforward:

Assume there are N nodes in the network. For i=1,2, . . . , n let Dᵢ be a constant with magnitude on the order of the desired cycle length C. During steady state operation of the CNS algorithm, node i records the start times (if any) of all transmissions it receives from its neighbors during observation period k. Node i sets the start time for cycle k+1 to the average of these neighbor start times (including its own) plus the fixed value Dᵢ.

To gain intuition about the CNS algorithm, consider the situation in which all clocks are perfect and link latencies are zero. In this case (as is shown later), the value of each Dᵢ is the desired cycle length C. The CNS algorithm then requires each node to set cycle start times to the average of all the neighbor start times plus C. The effect of averaging spreads throughout the network; it eventually causes synchronization of cycle start times. If the perfect clock assumption is relaxed, the intuition is similar; averaging causes cycle start times and lengths to synchronize. The need for node specific Dᵢ values only shows up when realistic link latencies are included. In this case, cycle lengths converge, but to a value that is dependent in part on latencies. The variation among Dᵢ values effectively counteracts this, removing any dependency of cycle length on latencies.

The CNS algorithm consists of two phases, an initialization phase during which the Dᵢ are the same across all nodes, and the primary operation phase during which the Dᵢ values differ from node to node. Operation in both phases is identical except for the change in Dᵢ value; the purpose of the initialization phase is to allow the CNS algorithm to converge to a steady state during which Dᵢ values can be determined. Conversion from initialization to primary operation phase does not require synchronization among the nodes, but can instead take place over the course of several (even thousands of) cycles with some nodes in initialization mode and others in primary operation mode. In practice, nodes can be programmed to switch from initialization to primary operation at a specific (local) cycle.

Formally, the CNS algorithm is as follows. Let s(k) (with appropriate subscripts and superscripts) denote the start time of cycle k, Uᵢ denote the set of neighbors of node i, and [Uᵢ] denotes the cardinality of Uᵢ.

II.c.1. Initialization Phase

1. Each node initially transmits for an interval of T time units, as measured by its local clock.

2. At the end of the kth transmission period, each node sets the start time of transmission period k+1 to the average of all the start times observed (if any, and including its own) during observation period k, plus the fixed value C. That is,

$${s}_{i}^{i} ( k + 1 ) = C + \frac{1}{\vert Ui \vert} {\sum }_{j ∈ {U}_{i}} {s}_{j}^{i} ( k ) \qquad ( 3 )$$

The adjustment required to change the start time of the subsequent cycle is “absorbed” by the adjustment period.

3. Once a predetermined cycle instant, called the alpha cycle or point, is reached, the nodes start observing (for several cycles, say k in K) the difference,

$${u}_{i} ( k ) = - \frac{1}{\vert Ui \vert} ( {\sum }_{j ∈ {U}_{i}} {s}_{j}^{i} ( k ) ) - {s}_{j}^{i} ( k ) \qquad ( 4 )$$

between the average start time of its neighbors (including itself) during a cycle and its own start time during the same cycle. Dᵢ is then defined by

$${D}_{i} = C - \frac{1}{\vert K \vert} {\sum }_{k ∈ K} {u}^{i} ( k ) \qquad ( 5 )$$

Once Dᵢ has been computed, the node moves into primary operation mode. The value of Dᵢ remains fixed until either the network goes offline or a complete restart is required, in which case the nodes start the process all over again beginning with the initialization phase. In Equation (5) above, it is required that K satisfies the criteria

$$K > \frac{max ( {l}_{ji} ) Vj ∈ {U}_{j}}{C} \qquad ( 6 )$$

II.c.2. Primary Operation Phase

1. At the end of the kth transmission period, each node sets the start time of transmission period k+1 to the average of all start times observed (if any, and including its own) during observation period k, plus the fixed value Dᵢ. Assuming that start times are received from all neighbors during each cycle, then

$${S}_{i}^{i} ( k + 1 ) = {D}_{i} + \frac{1}{\vert Ui \vert} {\sum }_{j ∈ {U}_{i}} {s}_{j}^{i} ( k ) . \qquad ( 7 )$$

II.d. Analysis

It is assumed initially that link latencies are small enough that in steady state operation start times of the kth transmission period are observed during the kth observation period. In practice, the start of the kth cycle on one node may not be observed on a neighboring node until several hundred cycles later.

The analysis begins with a look at the core CNS algorithm: setting the start time of a cycle to the average of the previous start time plus a fixed (and possibly node specific) constant. So, for each integer i Σ[1,N] let Mᵢ be fixed and assume in addition that the Mᵢ values are relatively close. (This assumption is not necessary if the stretchable adjustment period length is allowed to be as large as necessary to run the CNS algorithm. That is, the adjustment period needs to be long enough to allow a node to set the next start time to the value dictated by the CNS algorithm.) Consider the following generalization of equation (7).

$${S}_{i}^{i} ( k + 1 ) = {M}_{i} + \frac{1}{\vert Ui \vert} {\sum }_{j ∈ {U}_{i}} {s}_{j}^{i} ( k ) . \qquad ( 8 )$$

This can be written in terms of absolute time as

$${S}_{i} ( k + 1 ) = \frac{{M}_{i}}{{r}_{i}} + \frac{1}{\vert Ui \vert} {\sum }_{j ∈ {U}_{i}} ( {s}_{j}^{i} ( k ) + {1}_{ji} ) . \qquad ( 9 )$$

This can also be expressed in matrix form. Specifically, let H be the adjacency matrix that captures the network topology:

$${H}_{ij} = \{ \begin{matrix}1 , & j ∈ {U}_{i} \\ 0 , & otherwise\end{matrix}$$

Using H, equation (9) can rewritten as

$${s}_{i} ( k + 1 ) = \frac{{M}_{i}}{{r}_{i}} + \frac{1}{{\sum }_{j} {H}_{ij}} {\sum }_{j} {H}_{ij} ( {s}_{j} ( k ) + {1}_{ji} ) . \qquad ( 10 )$$

If the stochastic adjacency matrix G is defined by

$${G}_{ij} = \frac{H {i}_{i}}{{\sum }_{j} {H}_{ij}} = \frac{{H}_{ij}}{degree of node i} , \qquad ( 11 )$$

where the degree of node i includes the count of the self-loop, then (10) becomes

$${s}_{i } ( k + 1 ) = \frac{{M}_{i}}{{r}_{i}} + {\sum }_{j = 1}^{N} {G}_{ij} ( {s}_{j} ( k ) + {1}_{ji} ) . \qquad ( 12 )$$

where N denotes the number of nodes in the network. Let S(k) denote the N×1 column matrix whose entries are the sᵢ(k), M denote the N×1 column matrix whose entries are the M/rᵢ, and L denote the N×M matrix whose ij entry is lᵢⱼ. Finally, define diag(A) for an N×N matrix A to be the N×1 matrix whose ith entry is Aᵢᵢ. Then (12) can be rewritten as
S(k+1)=GS(k)+diag(GL)+M (13)

A closed form solution for this equation is

$$S ( k ) = {G}^{k} S ( 0 ) + {\sum }_{i = 0}^{k - 1} {G}^{i} ( M + diag ( G L ) ) \qquad ( 14 )$$

where k is any nonnegative integer. Cycle lengths can be determined by looking at the differences of successive start times.
S(k+1)−S(k)=(G^{k+1}−G^{k})S(0)+G^{k}(M+diag(GL)). (15)

In section II.e. it is shown that under the network topology assumptions, the powers of G converge to a stochastic matrix Q, all of whose rows are identical. Thus,

$${lim}_{k \to ∞} ( S ( k + 1 ) - S ( k ) ) = Q ( M + diag ( GL ) ) . \qquad ( 16 )$$

Since the limit is a column vector in which all entries are the same, cycle lengths converge to the same absolute length at each node. In addition, and perhaps more important, once the algorithm has reached steady state, start times remain locked relative to the start times of neighbor nodes. That is, there is no phase shift.

In the initiation phase of the algorithm, the value of each Mᵢ is C, and in the primary phase Mᵢ=Dᵢ, so the above analysis shows that the CNS algorithm converges in both phases, and that the rate of convergence is determined by the rate of convergence of the powers of G. In addition, the limiting cycle length depends in part on diag(GL), which is a term that captures the effects of link latencies. Specifically, (diag(GL)ᵢ)=(GL)ᵢᵢ. Since the jth entry in the ith row of G is nonzero if and only if j is a neighbor of i, and ith row of G effectively lists the neighbors of i. The ith column of L on the other hand, lists the latencies from neighbors of i into i. Thus (GL)ᵢᵢ (and (diag(GL)i)) is the average of link latencies on links toward i.

As mentioned above, the definition of Dᵢ is designed to counteract this dependence on link latencies. To simplify the analysis in this case, assume that the set K in equation (5) consists of the single value 0. Then Dᵢ is defined by

$${D}_{i} = C + {s}_{i}^{i} ( 0 ) - \frac{1}{\vert U i \vert} {\sum }_{j ∈ {U}_{i} }^{} {s}_{j}^{i} ( 0 ) .$$

Substituting this into equation (7) gives

$${s}_{i}^{i} ( k + 1 ) = C + {s}_{i}^{i} ( 0 ) - \frac{1}{\vert U i \vert} {\sum }_{j ∈ {U}_{i}}^{} {s}_{j}^{i} ( 0 ) + \frac{1}{\vert U i \vert} {\sum }_{j ∈ {U}_{i}}^{} {s}_{j}^{i} ( k ) .$$

In absolute terms, this becomes

$${s}_{i}^{i} ( k + 1 ) = \frac{C}{{r}_{i}} + {s}_{i} ( 0 ) - \frac{1}{\vert U i \vert} {\sum }_{j ∈ {U}_{i}}^{} ( {s}_{j} ( 0 ) + {1}_{ji} ) + \frac{1}{\vert U i \vert} {\sum }_{j ∈ {U}_{i}} {s}_{j} ( k ) + {l}_{ji} )$$

Moving to matrix notation, the analogue of equation (13) is
S(k+1)=C−G S(0)−diag(GL)+G S(k)+diag(GL)+S(0)=C+(I−G)S(0)+G S(k).
The corresponding closed form solution is

$$S ( k ) = S ( 0 ) + {\sum }_{i = 0}^{k - 1} {G}^{i} C ,$$

such that,
S(k+1)−S(k)=G^{k}C→QC.
The limit in this case is a weighted sum of the C/rᵢ and is independent of the values of the link latencies.

If clock drift rates are required to satisfy |l−rᵢ|<δ for some fixed δ, then the limiting cycle length, C_{L}, satisfies

$$\frac{C}{1 + δ} < {C}_{L} < \frac{C}{1 - δ} . \qquad ( 17 )$$

A realistic value for δ is 0.0001, which corresponds to clocks that are accurate to 100 parts per million. For 125 μs cycle lengths, this guarantees a limiting cycle length between 124.9875 μs and 125.01261 μs, or less than one hundredth of a percent deviation from the desired length.

It is natural at this point to question the need for the initialization phase, since the previous analysis set Dᵢ values according to the observed start time for the first cycle. In practice, start times for neighbor nodes may not be observable for several cycles. For example, with 125 μs cycles, a 10 ms delay corresponds to 80 cycles.

II.e. Convergence Behavior of G^{k}

Given that the rate at which the CNS algorithm reaches steady state depends on the convergence properties of G^{k}, there is a need to determine the conditions under which G^{k} converges, the limit when it does converge (and the sense in which we man “limit”), and the rate of convergence.

We begin with the issue of the conditions under which G^{k} converges. G is a finite stochastic matrix, and thus it must be the transition matrix for a finite Markov chain. Specifically, let G be the graph that represents the topology of the Cyclone network (including self-loops), and consider the Markov process corresponding to a “traveler” moving randomly (along edges of G) from node to node on G, with the system in state Sᵢ at a particular time epoch if the traveler is located at node i during that epoch. G is the transition matrix for this finite Markov chain. Because G is connected and contains self-loops, the Markov chain is ergodic (irreducibility follows from being connected, aperiodicity from the self-loops). Among other properties, ergodicity guarantees that the powers G^{k} approach a matrix Q, in the sense that each entry of G^{k} approaches the corresponding entry of Q. Moreover, each row of Q is the same positive probability vector W, where W is the unique probability vector such that W G=W. Equivalently, if W=[w₁ w₂ . . . w_{N}], then the wᵢ are uniquely determined through the system of equations

$${\sum }_{i = 1}^{N} {w}_{i} = 1 ; {w}_{j} = {\sum }_{i = 1}^{N} {w}_{i} {G}_{ij} , j = 1 , 2 , … , N .$$

Since wᵢ represents the “long term” probability that the system is in state i, it is fairly intuitive that each wᵢ should be given by

$${w}_{i} = \frac{degree of node i}{Number of nonzero entries of G}$$

where here the degree of a node includes a count of the self-loop. A straightforward calculation verifies this result. To simplify notation, the number of nonzero entries of G is referred to as the degree of G, denoted degree(G), and denote the degree of node i by degree(i), such that

$${w}_{i} = \frac{degree ( i )}{degree ( G )} .$$

Given this value of the limiting matrix Q, the limiting cycle length L is given by

$$L = {\sum }_{i = 1}^{N} {w}_{i} {C}_{i} ( 0 ) = {\sum }_{i = 1}^{N} \frac{degree ( i )}{degree ( G )} {C}_{i} ( 0 ) \qquad ( 18 )$$

Since the initial cycle for node i has length (in absolute time) of C/rᵢ, then

$$L = {\sum }_{i = 1}^{N} \frac{degree ( i )}{degree ( G )} \frac{C}{{r}_{i}} \qquad ( 19 )$$

Thus L is, as stated earlier, a weighted average of initial cycle lengths.

Determining the rate of convergence is relatively straightforward in theory: the powers of the transition matrix of an ergodic Markov chain converge at a rate related to the moduli of the eigenvalues of the matrix. This can be observed by considering the spectral representation of G. Specifically, the (positive integral) powers of a diagonalizable stochastic matrix G are given by
G^{k}=Q+λ^{k}₁A₁+λ^{k}₂A₂+ . . . +λ^{k}ₘAₘ (20)
where the λᵢ are the non-one eigenvalues of G, Q is the limit of the powers of G, and the Aᵢ are differential matrices (i.e. each row of the matrix sums to zero) satisfying the following:
1) AᵢAⱼ=AⱼAᵢ=0 if i≠j
2) A^{k}ᵢ=Aᵢ, 1≦i≦m, k=1,2, . . .
3) AᵢQ=QAᵢ=0, 1≦i≦N.
4) ||A₁||≦1, i=1,2, . . . , m.
Viewed in this form, it is clear that G^{k} converges at the same rate as the largest of the moduli of the λᵢ. An eigenvalue with the largest moduli is referred to as a “submaximal” eigenvalue. That is, an eigenvalue is submaximal if its absolute value is equal to the maximum of the moduli of the set of non-one eigenvalues (note that 1 is an eigenvalue of any stochastic matrix, and that Q would be the corresponding matrix in the spectral representation). Since G^{k} converges, it is clear that the moduli of the λᵢ must be less than one. This also follows from one form of the Perron-Frobenius theorem which also asserts that the eigenvalue one has multiplicity one.

The matrix G corresponding to the networks under consideration here is diagonalizable. To see this, consider the non-normalized adjacency matrix H corresponding to G. Because all links in the underlying network are bidirectional, H is symmetric, and thus diagonalizable (and all of its eigenvalues are real). Normalizing (as defined by (11)) amounts to multiplying H on the left by a diagonal matrix D with strictly positive diagonal entries. Such a D must be invertible and have an invertible square root. Thus G=DH is similar to D^{-1/2}(DH)D^{1/2}=D^{1/2}HD^{1/2}. Since this last matrix is symmetric, G is similar to a symmetric matrix and thus it is diagonalizable and has only real eigenvalues.

Determining the eigenvalues of a matrix can be difficult. There are a few classes of topologies for which an explicit closed form solution for the eigenvalues can be found. One of these is a complete graph, in which the eigenvalues are easily seen to be 1 with multiplicity one (of course) and 0 with multiplicity N−1. The star topology is another whose eigenvalues are relatively easy to determine. A graph is called an N−star if the graph contains a total of N nodes: one “hub” node and N−1 leaf nodes. It can be shown that the non-one eigenvalues of the N−star are ½ with multiplicity N−2 and 1/N−½ with multiplicity one. Since |1/N−½|<½for N>1, the submaximal eigenvalue is ½, and G^{k} converges at the rate of O(½^{k}).

Although we are more concerned with upper bounds on convergence rates of G^{k}, it is of interest to observe a situation in which a lower bound on the convergence rate can be computed. Specifically, if each node in G has degree m, then each nonzero entry of G is 1/ₘ₊₁, and trace(G)=N/ₘ₊₁. Now, the trace of a matrix is equal to the sum of its eigenvalues, so since 1 is an eigenvalue of multiplicity one, the sum of the remaining eigenvalues is N/ₘ₊₁−1=N−m−1/ₘ₊₁. Let λ be a submaximal eigenvalue of G. In order for the sum of the non-one eigenvalues to equal the expression above, we must have

$$( N - 1 ) \vert λ \vert \geq \frac{N - m - 1}{m + 1}$$

or equivalently

$$\vert λ \vert \geq \frac{N - m - 1}{( m + 1 ) ( N - 1 )} .$$

Thus, the fastest that G^{k} can converge in this case is at the rate of

$${( \frac{N - m - 1}{( m + 1 ) ( N - 1 )} )}^{k} .$$

Finally, if graphs with unidirectional links are allowed, then in terms of convergence, a worst case is a “one way” ring, for which the modulus of the base p in the exponential convergence rate p^{k} can be made arbitrarily close to 1. Although this shows that convergence rates can in theory be relatively slow, this is not a practical limitation. As our simulation results show (for a bidirectional ring-—a situation for which computing closed form expressions for eigenvalues can be daunting), convergence rates will generally be slower than more favorable topologies, but still well within tolerable limits.

II.f. Enhancement: Minimize Buffering

In Equation (3) above, the value of k on both sides of the equation are only the same if the latency is less than one cycle length (at that given cycle). Otherwise, the k on the right-hand side is likely to be a few cycles behind the k on the left-hand side. For example, assuming the latency is equal to 3 cycle lengths, the start time of cycle N at the source node will not be visible at the destination node until cycle N+3. In any case, a node simply “processes” the incoming start times in subsequent arrival order. If sᵢ(k) makes use of sⱼ(l) in its computation, then sᵢ(k+1) will make use of sⱼ(l+1), and so on.

Because of the different clock drift rates and the initial startup phase (where cycle length at the nodes can vary), the FIFO processing of incoming start times can lead to cases where a node, when computing sᵢ(k), will have to depend on sⱼ values that had arrived at sᵢ a few cycle earlier, e.g. at k−N for some values of N (see FIG. 4). This node will therefore have to allocate buffers to store these incoming values until they are processed. Since we do not know at this time which parameters affect or determine the number of buffers, we need to modify the basic algorithm so that this number is bounded, preferably by as small a value as possible (e.g. 1 or 2). This is the basis for the “minimize buffer” modification.

When we are computing sᵢ(k+1), we look at the interval between sᵢ(k)−C and sᵢ(k)+C, i.e. two “windows” of length C centered at sᵢ(k) (see FIG. 5). Let sⱼ(l) be the next unprocessed incoming start time. If sⱼ(l) is within some C of either boundary, then we say that sⱼ(l) has (potentially) “drifted” too much to the right or to the left, or faster or slower with respect to sᵢ(k). In this case, instead of using sⱼ(l) as in the original algorithm, we use either sⱼ(l-1) if drifting to the left, or sⱼ(l+1) if drifting to the right. At the next cycle, we will then use sⱼ(l) or sⱼ(l+2), respectively.

Even though we are no longer using sⱼ(l), we cannot simply use the previous/next incoming start time value directly when computing the next start time since that would skew the average either too far to the past (since we have already used this value) or the future (since we are not supposed to use this value until the next cycle). To get around this problem, we add an “offset” value to each affected link, and either add to or remove from the averaging computation for the next and all subsequent cycles, such that they are unaffected by our jumping backward or ahead.

Formally, the basic CNS algorithm is modified in the following way. An offset value for each link, oⱼ(jεUᵢ), is defined which is initially set to 0. Equation (3) is then modified to take account the offset values:

$${s}_{i}^{i} ( k + 1 ) = C + \frac{1}{\vert Ui \vert} {\sum }_{j ∈ {U}_{i}} ( {s}_{j}^{i} ( l ) + {o}_{j} ) \qquad ( 21 )$$

Let sⁱⱼ(m) be the earliest sⁱⱼ that has arrived, but not yet used in the next cycle computation by node i. Let W be a window of size 2C centered sᵢ(k). Let E be a small interval of size ε, say 1/10 the size of C, at both ends of W. If sⁱⱼ(m) does not fall into either E, i.e.
sᵢ(k)−C+ε<sⁱⱼ(m)<sᵢ(k)+C−ε (22)
then we let sⁱⱼ(l) be sⁱⱼ(m). Otherwise, if sⁱⱼ(m) falls into the left E window (i.e. sⁱⱼ(m)<sᵢ(k)−C+ε), then we set sⁱⱼ(l) to be sⁱⱼ(m+1), and update oⱼ as follows:
oⱼ=oⱼ−(sⁱⱼ(m+1)−sⁱⱼ(m)) (23)

Similarly, if sⁱⱼ(m) falls into the right E window (i.e. sⁱⱼ(m)>sᵢ(k)+C−ε), then we set sⁱⱼ(l) to be sⁱⱼ(m−1), and update oⱼ as follows:
oⱼ=oⱼ+(sⁱⱼ(m)−sⁱⱼ(m−1)) (24)

Finally, we modify Equation (7) as well to take into account the offset values:

$${s}_{i}^{i} ( k + 1 ) = {D}_{i} + \frac{1}{\vert {U}_{i} \vert} {\sum }_{j ∈ {U}_{i}} ( {s}_{j}^{i} ( l ) + {o}_{j} ) \qquad ( 25 )$$

sⁱⱼ(l) and oⱼ are computed as described above.
II.g. Enhancement: Adding and Removing Nodes

A description is now presented on how the basic CNS algorithm can be modified to accommodate topology changes, with new nodes joining or existing nodes leaving a Cyclone network. It is assumed that:

The Cyclone network has reached “steady-state”, where the cycle length are the same everywhere, as measured by a wallclock.

The Cyclone network is still “connected” after the addition or removal of a node.

If a new node is being added, its data transmission period is less than the steady-state cycle length (both values as measured by its local clock).

If a new node is being added, it can monitor the network for a period of time to determine the steady-state cycle length before beginning actual operation, i.e. sending actual data.

First, consider the addition of a new node, say node A. Based on the assumption above, A will be able to determine the steady-state cycle length by listening on its coming links. If necessary, it can average this value over a number of cycles since the steady-state cycle lengths can still fluctuate a little due to factors such as clock drift and latency perturbation and computation round-offs. Once it is ready to join the network, A simply sets its cycle length to the average cycle length it observes on its incoming link (202 in FIGS. 2 and 3),

$${s}_{i}^{i} ( k + 1 ) = {s}_{i}^{i} ( k ) + \frac{1}{\vert {U}_{i} \vert} {\sum }_{j ∈ {U}_{i}} ( {s}_{j}^{i} ( k ) - {s}_{j}^{i} ( k - 1 ) ) \qquad ( 26 )$$

Let B be an existing node in the Cyclone network with an incoming link from A. B now has an extra incoming start time at each cycle. On one hand, it cannot simply use the incoming start time from A as is since this new addition will likely cause the average (start time) value in Equation (7) to change, and therefore changing the (steady-state) cycle length and subsequently throwing the whole network out of sync. On the other hand, B should not ignore A incoming start time completely because it should at least take into account any minor fluctuations in A's steady-state cycle length, in order to propagate this throughout the network so all nodes can make the proper adjustments. To satisfy both of these requirements, we make use of a “node-specific offset value” in a manner similar to the way link-specific offset values are used as described above in the Enhancement: Minimize Buffering subsection (i.e. subsection II.f.). When B detects A sending data for the first time, it factors the initial (steady-state) cycle length from A, say C_{A}, into its node-specific offset. Subsequent cycle length computations at B will then use this offset value to factor out only C_{A}, but still consider any fluctuations A may have caused.

Formally, we modify the algorithm again in the following way. We define an offset value for each node, p, which is initially set to 0. Equation (25) is then modified to take account the node-specific offset value:

$${s}_{i}^{i} ( k + 1 ) = {D}_{i} + \frac{1}{\vert {U}_{i} \vert} {\sum }_{j ∈ {U}_{i}} ( {s}_{j}^{i} ( k ) + {o}_{j} ) \qquad ( 27 )$$

At any given cycle, when a node detects that one or more new links are becoming “active” for the first time, it updates its p offset value by computing the average of the incoming start times both with as well as without the start times from the new links. Let Uᵢ be the set of neighbors including the new links and let Vᵢ be the set without the new links (i.e. the previous Uᵢ),

$${p}_{i} = {p}_{i} + ( \frac{1}{\vert Vi \vert} {\sum }_{j ∈ {V}_{i}} ( {s}_{j}^{i} ( k ) + {o}_{j} ) ) - ( \frac{1}{\vert {U}_{i} \vert} {\sum }_{j ∈ {U}_{i}} ( {s}_{j}^{i} ( k ) + {o}_{j} ) ) \qquad ( 28 )$$

We handle the case when an existing node leaves the network in a similar manner. We factor the effect this node would have in the averaging value, such that subsequent cycle length computations will be carried out as if the node is still there. This is necessary so that the steady-state cycle length does not change. Let Uᵢ be the set of neighbors without the removed links and let Vᵢ be the set with the removed links still left in (i.e. the previous Uᵢ), pᵢ is computed exactly as in Equation (28), as we simply swap the role of Uᵢ and Vᵢ when deleting a node.

III. Simulation Results

In section III, simulation results are provided to validate the analysis given in section II. Specifically, it is shown that the converged cycle lengths followed Equation (17). In addition, it is shown how fast, in terms of wall clock time, the CNS algorithm converges for the various network topologies.

III.a. Setup

The clock drift is simulated at each node by specifying the r value, and Equation (1) is used to convert a local time to the global time, or Equation (2) is used to convert the local time between two nodes. All arithmetic operations are carried out with finite precision. It is assumed that the network operates at 10 GHz, with a 125 μs cycle length (or about 8000 cycles per second). It is also assumed that the granularity of the timestamp clock is accurate to a within a single clock tick, or 100 picoseconds.

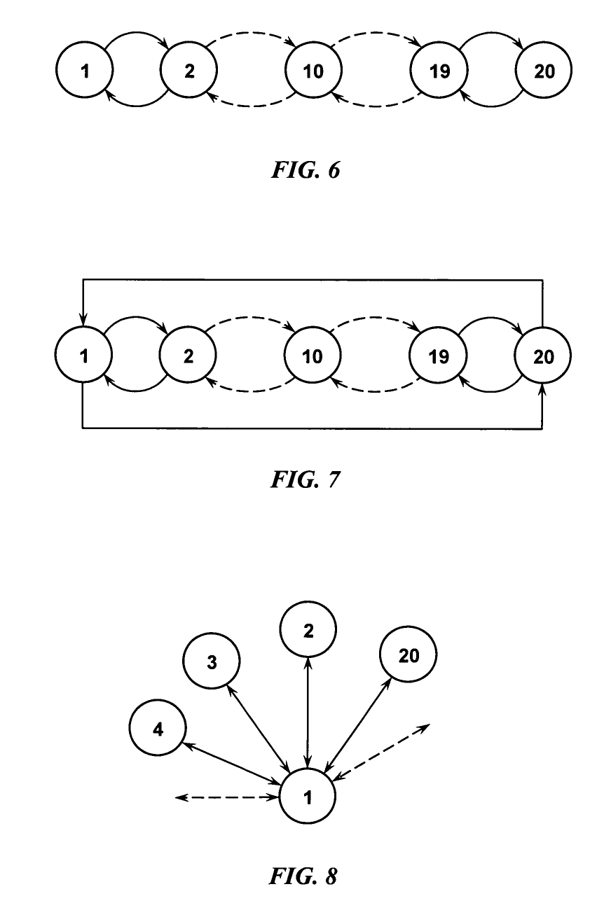

Unless otherwise noted, the “baseline” simulation data will consist of the following Cyclone network:
The desired cycle length is 125 μs.
20 nodes organized in a “chain” topology (see FIG. 6).
Links are unidirectional, with latencies being random values between 0 and 200 million clock ticks (or about 160 cycles).
Clock drift rates are between 0.9991 and 1.0009, or equivalent to clocks that are accurate to about 100 parts per million.
The alpha point in the initialization phase is set at the 2000^{th} cycle.
K in Equation (6) is set to 1000.

The goal of the CNS algorithm is to enable the nodes in the network to reach “convergence”, or “steady-state”, whereby the limiting or converged cycle length satisfies Equation (17). Note that the converged cycle length may fluctuate a little bit due to factors such as finite precision calculation roundings.

In the simulations, the following criteria are used to determine if and when a network has reached convergence.

Let T be the number of total cycles (per node) the CNS algorithm will execute. To be more precise, since the nodes can have different clock drifts, not all of them will execute for exactly T cycles. Instead, the first node that reaches the T^{th} cycle will terminate the simulation. As the simulation progresses, two sets of statistics are kept tack along the way. However, since we are mainly interested in the steady-state behavior, and not with the behavior of the network at the beginning while adjustments are being made, these statistics are collected only from the point where it is believed that convergence has been reached. Let S be the cycle at this point, therefore statistics are only kept from the S^{th} to the T^{th} cycle.

The first statistic kept track of is the cycle length at each node during the simulation. In addition, for the purpose of aiding in the calendar scheduling at a Cyclone node, there is also an interest in keeping track of when an incoming cycle will arrive, relative to the current local cycle, on all the incoming links. If there is no fluctuation in the cycle lengths at all of the nodes once convergence is reached, then an incoming cycle will always arrive at exactly the same point relative to the start time at the local node. However, converged cycle lengths do fluctuate as mentioned above. Subsequently, the “time offset” between the start of an incoming cycle and the start of the corresponding cycle at the local node will fluctuate as well (we refer to this fluctuation as the “start time offset jitter”). The goal is to make sure that both cycle length jitter as well as start time jitter are bounded.

Let maxCycleLen (minCycleLen) be the maximum (minimum) cycle length observed at any node in the network during the period from cycle S to cycle T. For each incoming link to a node, let maxStartOffset (minStartOffset) be the maximum (minimum) start time offset (between the start of the local cycle and the incoming start time) observed at any node in the network during the period from cycle S to cycle T.

It is said that the network has reached convergence if, from S until T, the following holds true

$$maxCycleLen - minCycleLen < {∈}_{i} \\ maxStartOffset - minStartOffset < {∈}_{j} \qquad ( 29 )$$

for some εᵢand εⱼ. Both ε values are specified to be 10 units (or clock ticks) in the simulations. In other words, once convergence has been reached, the cycle length at each node should be “the same” (according to a wall clock), subjected to some bounded fluctuations or jitters. Similarly, incoming cycles to a node should always arrive at the same time, relative to the start time of the corresponding local (outgoing) cycle. We then say that it takes the network S cycles to converge.

S is varied accordingly to determine how fast the simulated network converges.

III.b. Network Topology

We start out by looking at how the different network layouts or topologies affect the convergence rate. We arrange N nodes (e.g. 20, 50, 100) in a chain (see FIG. 6), bidirectional cycle (see FIG. 7), star (see FIG. 8), and random layouts.

The remaining parameters (e.g., clock drift rates, latencies, etc.) are the same as the baseline network mentioned above.

Here, it is expected that the star network will converge the fastest since it has the smallest “longest path” (value of 2) of all the networks, allowing information such as cycle lengths to propagate around the network in fewer cycles. The chain network should converge the slowest since it has the largest “longest path” between nodes 1 and 20 (value of 19). The bidirectional networks are simply the chain with a connection between nodes 1 and 20, and therefore should converge at the same rate or slightly faster than the chain.

The random network is generated using the following pseudo-code:

```
put the N nodes into the set UNCONNECTED
initialize the set CONNECETED to Ø
remove 2 random nodes, X and Y, from
UNCONNECTED
connect X and Y bidirectionally
add X and Y to CONNECTED
while N is not empty
do
      pick a random node, A, in CONNECTED
      remove any node, B, from UNCONNECTED
      connect A and B bidirectionally
      put B into CONNECTED
end
```

Since the resulting network is connected and has the minimum number of (bidirectional) edges, it is “minimally connected”. A real-life network with the same number of nodes would probably be even better connected (i.e. have more edges) than our random network, and thus should converge even faster. In addition to the 20-node, 50-node, and 100-node networks, we also simulated 200-nodes, 500-nodes, and 1000-nodes networks (all random) to obtain an idea of how long such a large network would take to converge.

Table 1 shows the convergence rate for the various networks. The values in the table indicates the S value as defined above (i.e. the number of cycles we need to skip over before keeping track of the cycle length to determine whether the network has reached convergence or not).

As expected, the star networks converge the fastest, followed by the random network, with the chain and bidirectional being the slowest. With the exception of the 20-node networks, the larger networks seem to converge at a rate that is independent of the total number of nodes. We note that even in the worse case, convergence is reached in about 30 secs for a 10 Gbits network. In addition, if we allow the C value that is used to bound the cycle jitter to be larger than the above value of 10, the various network could possibly converge even faster.

TABLE 1
Convergence results for different network topologies.

| | | | | Uni- | |
|---|---|---|---|---|---|
| # Nodes | Star | Chain | Bidirectional | directional | Random |
| 20 | 15,000 | 40,000 | 40,000 | 8,000 | 32,000 |
| 50 | 120,000 | 500,000 | 500,000 | 20,000 | 250,000 |
| 100 | 120,000 | 500,000 | 500,000 | 20,000 | 250,000 |
| 200 | N/A | N/A | N/A | N/A | 250,000 |
| 500 | N/A | N/A | N/A | N/A | 250,000 |
| 1000 | N/A | N/A | N/A | N/A | 250,000 |

III.c. Alpha Point

In this simulation, we vary the “alpha” point (this is the point in the simulation where the cycle length computation changes) and see if its value affects the convergence rate. We used the 50-node star networks from the Network Topology simulations, and used various alpha points between 2000 and 75,000. Since the star network converges in about 120,000 cycles, it did not make sense for us to simulate with even larger alpha values since the network would need some non-zero number of cycles after the alpha point to stabilize. Table 2 shows the result of the simulations for a 50-star network with different “alpha” values.

TABLE 2
Results for 50-star network with different “alpha” values.

| | Alpha Value | | | | | |
|---|---|---|---|---|---|---|
| | 2,000 | 10,000 | 20,000 | 30,000 | 50,000 | 75,000 |
| Convergence | Yes | Yes | Yes | Yes | No | No |

Convergence was not possible for alpha values of 50,000 and 75,000 since we did not change the S value, and subsequently, the network did not have enough time to stabilize once the alpha point has been reached. Taking into account this fact, the results show that, for a given set of network parameters, the alpha point does not have an impact on the convergence rate. Thus, the smallest possible alpha point should be selected, in order to allow the network to more quickly reach convergence.

III.d. Network Latency

In the baseline configuration, the latency is a randomly generated value between 0 and a maximum of 200 million clock ticks (or roughly 160 cycles). In these simulations, the maximum value of ticks was varied from 20 million clock ticks (about 16 cycles) all the way to 10 billion clock ticks (about 8000 cycles, or 1 sec). The topology is a 20-node random network, with a diameter of 8.

TABLE 3
Convergence rate for different latency values.

| | Latency Value | | | | | | | | |
|---|---|---|---|---|---|---|---|---|---|
| | 20 | 50 | 100 | 200 | 500 | 1000 | 2000 | 5000 | 10000 |
| Con- | 150 | 150 | 150 | 250 | 400 | 400 | 700 | 900 | 1,800 |
| ver- | | | | | | | | | |
| gence | | | | | | | | | |
| Rate | | | | | | | | | |

Table 3 shows the results of the simulations. The latency values are in million of clock ticks and the convergence rates are in thousand of cycles. As expected, the network will take longer to converge for higher latency values, since the changes (or computations) at a node will take longer to propagate through the whole network. Even so, in the worst case, where the latency can be as high as 1 second, the CNS algorithm still converges in about 225 seconds.

Finally, although not obvious from the above results, there is one value that is directly affected by the latency and should be adjusted accordingly. This is the K value in Equation (6), which corresponds to how many cycles each node should compute the Dᵢ value once the “alpha point” has been reached. Intuitively, a node should keep on computing the Dᵢ values until it has received the information from all of its neighbors. This delay is determined by the latencies on its incoming links. Thus K should be greater than the maximum incoming link latency, when considers in term of the number of cycles. Since different nodes can have different incoming latencies, K can theoretically be different for each node. However, in practice, we use the same K value for all nodes. In the above simulations, K is set to 100,000 (cycles). Note that computing Dᵢ longer than necessary does not affect the convergence result. It would simply be wasted computation, and therefore should be set to the lowest possible value in an actual implementation of the CNS algorithm.

III.e. Clock Drift Rate

As shown in Equation (17), the limiting cycle length (or the converged cycle length) is a function of the clock drift. We simulated different clock accuracy ranging from 10 PPM to 10000 PPM. Table 4 shows the results of these simulations.

TABLE 4
Converge cycle length for different clock drift values.

| Δ | PPM | C/(1 + δ) | C/(1 − δ) | Actual | Deviation |
|---|---|---|---|---|---|
| .01 | 10000 | 1237623 | 1262626 | 1261351 | 1% |
| .001 | 1000 | 1248751 | 1251251 | 1251124 | .1% |
| .0001 | 100 | 1249875 | 1250125 | 1250111 | .01% |
| .00001 | 10 | 1249987 | 1250012 | 1250009 | .001% |

The δ is from Equation (17), PPM is the accuracy of an equivalent clock, Actual is the actual limiting cycle length obtained from the simulations, and Deviation is how much this cycle length deviates from the desired cycle length, or C. The results show that, assuming the hardware timestamp clock has a fine enough granularity, the amount of “padding” added by CNS to the cycle length to ensure that all nodes are synchronized is extremely small, even when using commodity clocks with accuracy with 1000 PPM or worse.

IV. Conclusion

The CNS algorithm according to the present disclosure does not depend on highly stable and expensive clocks or hardware, yet it can synchronize nodes in a network with a very high degree of accuracy. It is very light-weight since no explicit clock synchronization is performed, and subsequently does not incur any overhead in message passing. Instead, synchronization is done solely by listening to the regular network traffic. Finally, the amount of padding or time overhead incurred by the CNS algorithm is extremely small, even when used with system clocks that have high drift rates (e.g. 1000 PPM or more).

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. A device for coordinating among a plurality of nodes on a network the arrival and departure times of chunks, the device comprising:
incoming buffer means for storing chunks received from the plurality of nodes;
outgoing buffer means for storing chunks to be transmitted to the plurality of nodes; and
controller means for determining an arrival time of a chunk corresponding to an incoming cycle of a plurality of incoming cycles, and for determining a departure time for the chunk corresponding to an outgoing cycle of a plurality of outgoing cycles based on the determined arrival time.

2. The device of claim 1, wherein the device corresponds to a node of the plurality of nodes and coordinates the time at which chunks are received and transmitted by the node.

3. The device of claim 1, wherein the controller means determines the departure time by adding an adjustment time to a time required to transmit the chunk during the outgoing cycle, wherein a cycle duration length time computed as the adjustment time plus the time required to transmit the chunk during the outgoing cycle is the same across the entire network.

4. The device of claim 1, further comprising switch means for switching each of the chunks from a portion of the incoming buffer means to a portion of the outgoing buffer means at a switching time determined by the controller means.

5. The device of claim 4, wherein the switching time is one of prior to the determined departure time and substantially equal to the departure time.

6. A method for coordinating among a plurality of nodes on a network the arrival and departure times of chunks, the method comprising:
storing the chunks received from the plurality of nodes in an incoming buffer means;
storing the chunks to be sent to the plurality of nodes in an outgoing buffer means;
determining an arrival time of a chunk corresponding to an incoming cycle of a plurality of incoming cycles; and
determining a departure time for the chunk corresponding to an outgoing cycle of a plurality of outgoing cycles based on the determined arrival time.

7. The method of claim 6, wherein the method is performed by a device corresponding to a node of the plurality of nodes, said device coordinating the time at which chunks are received and transmitted by the node.

8. The method of claim 6, wherein the step of determining the departure time comprises adding an adjustment time to a time required to transmit the chunk during the outgoing cycle, wherein a cycle duration length time computed as the adjustment time plus the time required to transmit the chunk during the outgoing cycle is the same across the entire network.

9. The method of claim 6, further comprising determining a switching time for switching each of the chunks from a portion of the incoming buffer means to a portion of the outgoing buffer means; and
switching each of the chunks from a portion of the incoming buffer means to a portion of the outgoing buffer means at the determined switching time.

10. The method of claim 9, wherein the switching time is one of prior to the determined departure time and substantially equal to the departure time.

11. A data network comprising:
a plurality of hosts including a sending host for sending data in chunks and a receiving host for receiving the data; and
a plurality of intermediate nodes interconnecting the plurality of hosts;
wherein each of the plurality of intermediate nodes comprises:
incoming buffer means for storing the chunks when the chunks are received in said each of the plurality of intermediate nodes;
outgoing buffer means for storing the chunks to be sent from said each of the plurality of intermediate nodes; and
controller means for determining an arrival time of a chunk at said each of the plurality of intermediate nodes, and for determining a departure time for the chunk from said each of the plurality of intermediate nodes.

12. The data network of claim 11, wherein the controller means determines the departure time by adding an adjustment time to a time required to transmit the chunk during an outgoing cycle, wherein a cycle duration length time computed as the adjustment time plus the time required to transmit the chunk during the outgoing cycle is the same across the entire data network.

13. The data network of claim 11, wherein each of the plurality of intermediate nodes further comprises switch means for switching each of the chunks from a portion of the incoming buffer means to a portion of the outgoing buffer means at a switching time determined by the controller means.

14. The data network of claim 13, wherein the switching time is one of prior to the determined departure time and substantially equal to the departure time.

15. The data network of claim 11, wherein the data network in a Cyclone network.

16. An algorithm for coordinating among a plurality of nodes on a network the arrival and departure times of chunks, the algorithm being executed by at least one processor of the network for:
storing the chunks received from the plurality of nodes in an incoming buffer means;
storing the chunks to be sent to the plurality of nodes in an outgoing buffer means;
determining an arrival time of a chunk corresponding to an incoming cycle of a plurality of incoming cycles; and
determining a departure time for the chunk corresponding to an outgoing cycle of a plurality of outgoing cycles based on the determined arrival time.

17. The algorithm of claim 16, wherein the step of determining the departure time comprises adding an adjustment time to a time required to transmit the chunk during the outgoing cycle, wherein a cycle duration length time computed as the adjustment time plus the time required to transmit the chunk during the outgoing cycle is the same across the entire network.

18. The algorithm of claim 16, further comprising determining a switching time for switching each of the chunks from a portion of the incoming buffer means to a portion of the outgoing buffer means; and
switching each of the chunks from a portion of the incoming buffer means to a portion of the outgoing buffer means at the determined switching time.

19. The algorithm of claim 18, wherein the switching time is one of prior to the determined departure time and substantially equal to the departure time.

20. The algorithm of claim 16, wherein the data network in a Cyclone network.
